(19) United States
(12) Patent Application Publication
(10) Pub. No.: US 2010/0104812 A1
(43) Pub. Date: Apr. 29, 2010

(54) OPTICAL SHEET AND MANUFACTURING METHOD THEREFOR

(76) Inventors: Chang-Chih Sung, Zhongli City (TW); Chen-Sheng Lee, Zhongli City (TW); Yun-Pin Yang, Zhongli City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/408,412

(22) Filed: Mar. 20, 2009

(30) Foreign Application Priority Data
Oct. 28, 2008 (TW) 097141499

(51) Int. Cl. B32B 3/00; G02B 1/12; B29D 11/00

(52) U.S. Cl. 428/156; 264/1.36; 264/1.38

(57) ABSTRACT

The present invention provides an optical sheet placed in a backlight assembly and the manufacturing method therefor. There are pluralities of first microstructures on the surface of the optical sheet. The optical sheet is mainly made of cured photo resin, for instance: ultraviolet glue. The optical sheet has higher performance and lower cost.

### BACKGROUND OF THE INVENTION

1. Field of the Invention

The invention is an optical sheet, especially an optical sheet in a backlight assembly.

2. Description of the Prior Art

A liquid crystal display emits lower radiation than a cathode ray tube display, and the manufacturing cost of the liquid crystal display has been reduced obviously recently. This is why the cathode ray tube display has been gradually replaced by a liquid crystal display. In general, the liquid crystal display includes a backlight assembly and a LCD panel. The backlight assembly is responsible for providing light to the LCD panel.

Please refer to FIG. 1A, a conventional backlight assembly is shown. The backlight assembly 100 includes pluralities of cold cathode fluorescent lamps 110, a reflector 120, a diffusion plate 130, a diffusion film 142, and a brightness enhancement film 144. The cold cathode fluorescent lamps 110, arranged at a plurality of intervals, are used to provide light. The reflector 120 is used to reflect the light produced by the cold cathode fluorescent lamps 110 toward the diffusion plate 130. In order to solve the problem of non-uniformity in brightness on the image displaying surface of the LCD panel (not shown), the diffusion plate 130 is placed to diffuse the light, emitted from the cold cathode fluorescent lamps 110, therefore providing a more uniform light emergence to the LCD panel.

In present time, the diffusion plate 130 is made by the injection molding method. However, as lighter and thinner displays have gained in popularity, the diffusion plate 130 must be made with thinner thickness. With the diffusion plate 130 becoming thinner, the manufacturing parameters, for instance: the temperature of core in the mode, are becoming harder to control. This will lower the yield of the diffusion plate 130. Furthermore, the diffusion plate 130 is made of poly-methyl-methacrylate, which is like to absorb water, so the diffusion plate 130 is easy to become bending.

However, the problem in non-uniformity in brightness cannot be completely solved only by placing the diffusion plate 130, therefore placing the diffusion film 142 on the diffusion plate 130 is necessary. In order to enhancing the brightness in the viewing angle, it is necessary to add the brightness enhancement film 144 on the diffusion film 142. The brightness enhancement film 144 is approximately between 0.062 mm and 0.375 mm. There are pluralities of prism-shaped structures 144a on the brightness enhancement film 144. The prism-shaped structures 144a can reduce the angle of the emergence light, so the brightness enhancement film 144 is able to condense the light, and the brightness can be enhanced in the viewing angle of the backlight assembly 100.

Please refer to FIG. 1B, the top view of the brightness enhancement film in FIG. 1A is shown. The brightness enhancement film 144 is mainly comprised of a base plate 144a and a structured layer 144b. The base plate 144a is about 175 μm and made of polyethylene terephthalate. The structured layer 144b is about 25 μm and made of photo resin.

However, the installment of the base plate 144a will increase the material cost. Furthermore, after entering into the incident surface 144c of the brightness enhancement film 144, the light 11 must passes through two different mediums before emitting from the emergence surface 144d, and this will cause increase in light loss. Otherwise, the designer must consider more valuables when designing the brightness enhancement film 144, so the difficulty in designing will increase.

Hence how to increase the yield of the diffusion plate 130, lower the material cost of the brightness enhancement film 144, and decrease the difficulty in designing the brightness enhancement film 144 is an issue remained to be resolved in the industry.

### SUMMARY OF THE INVENTION

The invention aims to provide an optical sheet which has lower material cost, reduce light loss, and decrease the difficulty in design.

To achieve the foregoing objective and other objectives, the invention provides an optical sheet placed in a backlight assembly. There are pluralities of first microstructures on the surface of the optical sheet. The optical sheet is mainly made of cured photo resin.

To achieve the foregoing objective and other objectives, the invention provides a manufacturing method for an optical sheet. The manufacturing method includes the following steps. First, a forming module, which has pluralities of second microstructures on its surface, is provided. A layer of uncured photo resin is coated over the second microstructures of the forming module. Second, a pressing plate is covered on the uncured photo resin. The pressing plate is made of a transparent material that is not prone to crosslinking to the photo resin. Thereafter, the photo resin is cured to form an optical sheet. Then, the optical sheet is left from the forming module and the pressing plate.

To achieve the foregoing objective and other objectives, the invention provides another manufacturing method for an optical sheet. First, a transmission band, which is made of a transparent material that is not prone to crosslinking to a photo resin, is provided. A layer of photo resin is coated on the transmission band. In the proceeding step, a roller, which has stamping patterns on its surface, is provided. The roller is made of a material that is not prone to crosslinking to the photo resin. The roller is pressed on the photo resin for transferring the stamping patterns to the photo resin to form pluralities of first microstructures on the photo resin. Then, a light source disposed below the transmission band is provided. The light source irradiates the light on the first microstructures for curing the first microstructures. Thereafter, the cured photo resin is separated from the transmission band. Then, the cured photo resin is cut into pluralities of optical sheets.

To achieve the foregoing objective and other objectives, the invention provides a manufacturing apparatus for an optical sheet. The manufacturing apparatus includes a container, a transmission band, a roller, a light source, and a product storage device. The container includes a valve and contains a liquid photo resin. The transmission band is released by a band releasing wheel and storied by a band storage wheel. The transmission band, made of a transparent material that is not prone to crosslinking to the photo resin, is passed through the below of the valve. The photo resin outflowed from the valve is disposed on the transmission band. There are pluralities of stamping patterns on the surface of the roller. The roller, made of a material that is not prone to crosslinking to the photo resin, is placed above the transmission band and pressing the photo resin disposed on the transmission band. The light source is placed under the transmission band and irradiating on the pressed photo resin to make the photo resin be cured. The product storage device is used for storing the cured photo resin.

In conclusion, in the present invention, the optical sheet has no base plate, so the material cost and thickness can be reduced. The light, after entering into the incident surface of the optical sheet, just only passes through one medium before emitting from emergence surface. This will reduce the light loss, decrease the variables that the designer of the optical sheet must consider, and then decrease the difficulty in design. In short, the optical sheet has higher performance and lower cost.

The foregoing, features and advantages of the invention will be more readily apparent from the following detailed description, which proceeds with reference to the accompanying drawings. The drawings are not made to the scale, and are for reference only.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a conventional backlight assembly.

FIG. 1B shows the top view of the brightness enhancement film.

FIG. 2A to FIG. 2E shows the manufacturing process of optical sheet of the embodiment in this invention.

FIG. 3 shows the forming module used to manufacture the optical sheet with diffusion capability.

FIG. 4 shows an optical sheet of another embodiment in this invention.

FIG. 5 shows an optical sheet of the other embodiment in this invention.

FIG. 6 shows the manufacturing apparatus for the optical sheet.

FIG. 7 shows another manufacturing apparatus for the optical sheet.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

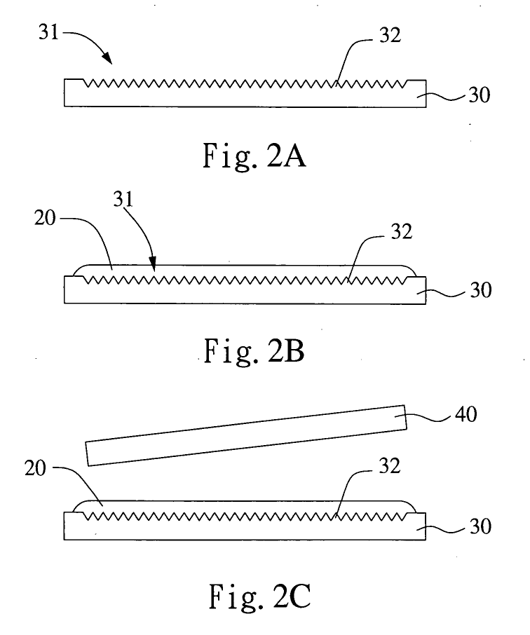

Please refer to FIG. 2A to FIG. 2E, the manufacturing process of optical sheet of the embodiment in this invention is shown. First, please refer to FIG. 2A, a forming module 30 which has pluralities of second microstructures 32 is provided. The second microstructures 32 are prism-shape troughs. The forming module 30 is made of metal, for instance: nickel. Furthermore, the surface 31 of the forming module 30 is coated with Teflon.

Then please refer to FIG. 2B, a liquid photo resin 20 with viscosity above 50 cps is coated on the surface 31 of the forming module 30. The photo resin can be cured when irradiated by light within certain wavelength band regions. In this embodiment, the photo resin 20 is ultraviolet glue.

Please refer to FIG. 2C, a pressing plate 40 is covered on the photo resin 20. The pressing plate 40 is made of transparent material, for example: glass, oriented polypropylene, or other transparent material that is not prone to crosslinking to the photo resin 20.

Thereafter, please refer to FIG. 2D, a light source is used to irradiate the photo resin 20. Because the pressing plate 40 is made of transparent material, the light emitted from the light source 50 will pass through the pressing plate 40 and be irradiated on the photo resin 20 to make it cured. In this embodiment, the light source 50 is ultraviolet light source.

The pressing plate 40 is made of the material that is not prone to crosslinking to the photo resin 20, so the pressing plate 40 can be easily left when the photo resin 20 is cured. Furthermore, the Teflon is coated on the forming module 30 and the Teflon is not prone to crosslinking to the photo resin 20, so the photo resin 20 can be picked up easily. Therefore, the formed photo resin 20 is an optical sheet 60 with pluralities of first microstructures 62 as shown in FIG. 2E.

Compared with the brightness enhancement film 144, the optical sheet 60 has no base plate, so the material cost and thickness can be reduced. In this embodiment, the thickness of the optical sheet 60 is about 50 μm. In this invention, the thickness of the optical sheet 60 is defined as the distance between the incident surface 62 of the optical sheet 60 and the top of the microstructures 61. Furthermore, compared with the brightness enhancement film 144, after entering into the incident surface 62 of the optical sheet 60, the light 12 just only passes through one medium before emitting from emergence surface 63. This will reduce light loss, decrease the variables that the designer of the optical sheet 60 must consider, and then decrease the difficulty in design. In short, compared with the brightness enhancement film 144, the optical sheet 60 has higher performance and lower cost.

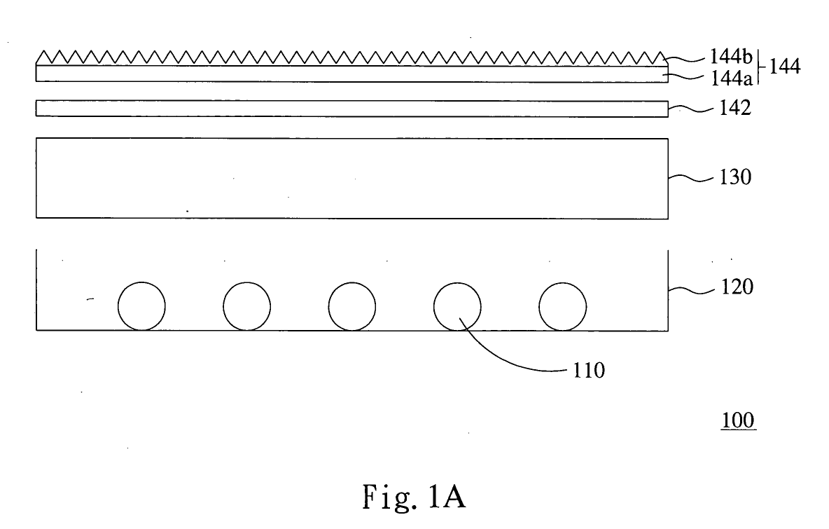

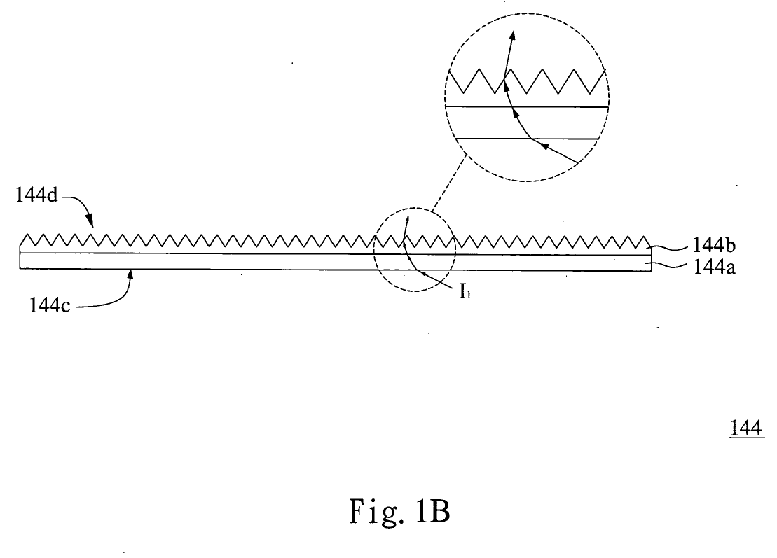

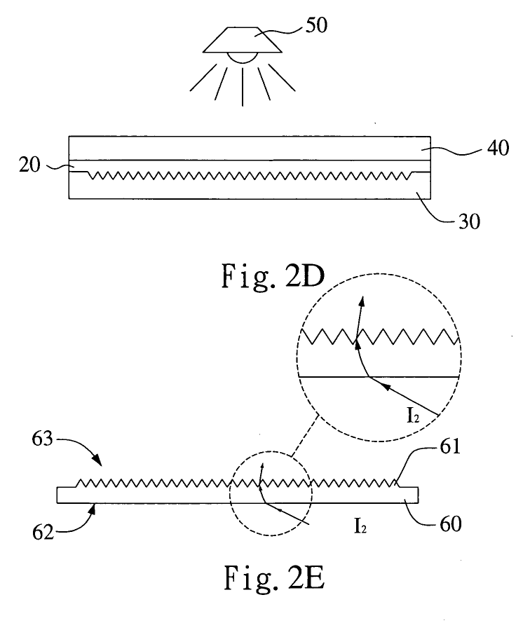

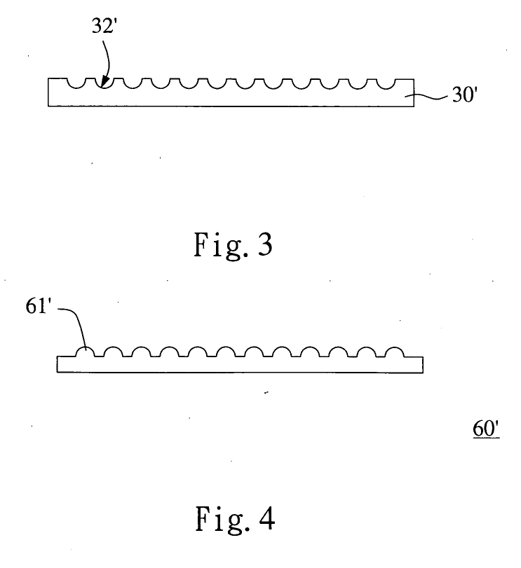

Not only can the optical sheet 60 having condensing capability be manufactured by the processes shown in FIG. 2A to FIG. 2E, but also the optical sheet having diffusion capability as well. The optical sheet with diffusion capability can be used to replace the diffusion film 142. Please refer to FIG. 3, the forming module used to manufacture the optical sheet with diffusion capability is shown. The main difference between the forming module 30′ and the forming module 30 shown in FIG. 2A is that the second microstructures 32′ of the forming module 30′ are semi-sphere troughs. After the photo resin 20 (shown in FIG. 2B) being coated on the forming module 30′ and being processed by the processes in FIG. 2C and FIG. 2D, the optical sheet 60′ shown in FIG. 4, with thickness between 0.1 mm and 0.2 mm, will be formed. Because of the semi-sphere first microstructures 61′, the optical sheet 60′ has the diffusion capability and can replace the diffusion film 142 in the backlight assembly 100 shown in FIG. 1A. Furthermore, compared to the diffusion film 142 with the base plate 144a, the optical sheet 60′ has thinner thickness and lower material cost. In FIG. 4, the first microstructures 61′ is arranged with a fixed space to the other, but those skilled in the art can arrange the first microstructures 61′ in random.

The first microstructures 61 and the first microstructures 61′ are both protruded outwardly, but those skilled in the art can design the first microstructures of other shapes, for instance: a sunken trough, in order to achieve the specific characteristic of the optical sheet.

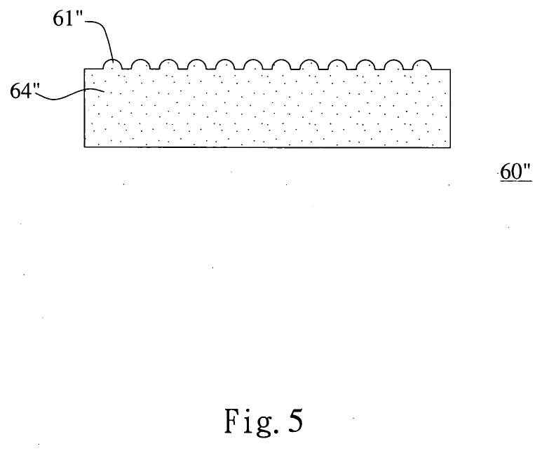

Furthermore, the uncured photo resin 20 can be thickened and added with pluralities of light diffusion particles, in order to form the optical sheet 60″ shown in FIG. 5. The light diffusion effect of the optical sheet 60″ can be enhanced not only by the semi-sphere first microstructures 61″ but also by the light diffusion particles 64″. With thicker thickness and light diffusion effect, the optical sheet 60″ can replace the diffusion plate 130 in the backlight assembly 100.

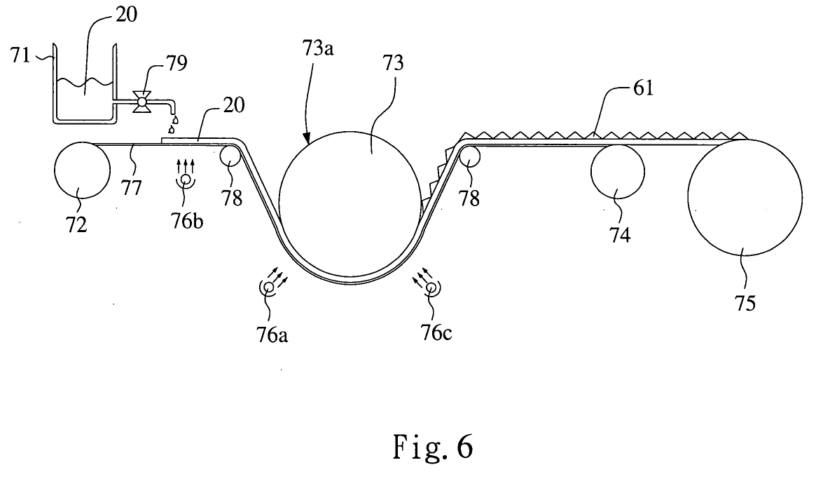

In the followings, the manufacturing process of the optical sheet of another embodiment in this invention is described. Please refer to FIG. 6, the manufacturing apparatus for the optical sheet is shown. The manufacturing apparatus includes a container 71, a band releasing wheel 72, a roller 73, a band storage wheel 74, a product storage wheel 75, a first light source 76a, a second light source 76b, a third light source 76c, a transmission band 77, an assisting wheel 78, and a valve 79. The liquid photo resin 20 with viscosity above 50 cps is contained in the container 71. The outflow amount of photo resin 20 can be controlled by the valve 79. By controlling the valve 79, the thickness of the photo resin 20 deposited on the transmission band 77 can be controlled. The transmission band 77 is released by the band releasing wheel 72 and storied by the band storage wheel 74. The transmission band 77 is made of the transparent material, for instance: oriented polypropylene, that is not prone to crosslinking to the photo resin 20.

In this embodiment, the first light source 76a, the second light source 76b, and the third light source 76c are all ultraviolet lamp. The second light source 76b is used for curing the photo resin 20 initially. After being cured initially, the photo resin 20 is pressed by the roller 73. There are pluralities stamping patterns (not shown) disposed on the surface 73a of the roller 73. After being pressed by the roller 73, the stamping patterns will be transferred to the photo resin 20 to form the first microstructures 61. The roller 73 is made of the material that is not prone to crosslinking to the photo resin 20, so the photo resin 20 will not be adhered to the roller 73. In this embodiment, the first microstructures 61 are prism-shape lumps, so the stamping patterns are prism-shape troughs.

When being pressed by the roller 73, the photo resin 20 is irradiated by the first light source 76a and the third light source 76c in order to be further cured.

In this embodiment, there are three light sources. However, those skilled in the art can adjust the number of light sources, for example: just placing one light source or three above light sources.

The transmission band 77 is made of the transparent material that is not prone to crosslinking to the photo resin 20, so the cured photo resin 20 can be separated from the transmission band 77 and wound on the product storage wheel 75. The photo resin 20 can be taken off and cut into pluralities of the optical sheets 60 shown in FIG. 2E.

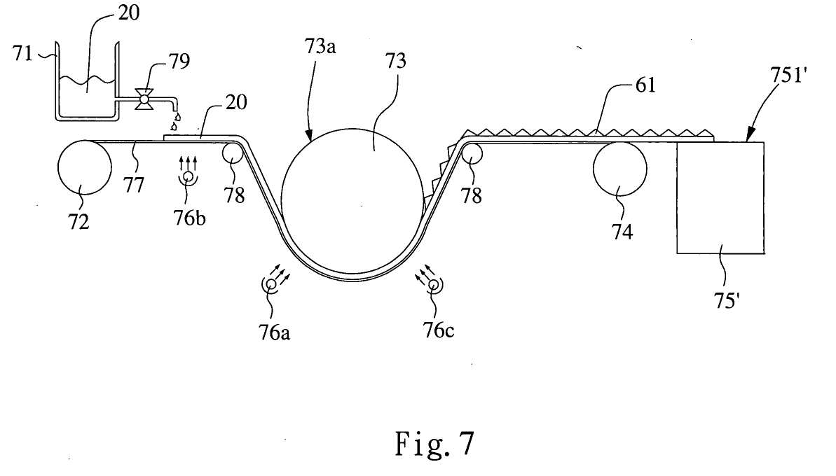

Please refer to FIG. 7, another manufacturing apparatus for the optical sheet is shown. The main difference between the manufacturing apparatus in FIG. 7 and the manufacturing apparatus in FIG. 6 is: the cured photo resin 20 is placed on the placing surface 751′ on the placing platform 75′ instead of the product storage wheel 75 for the following processing, for example: cutting.

By adjusting the parameters and changing some parts of the manufacturing apparatus in FIG. 6 and FIG. 7, those skilled in the art can manufacture other types of optical sheet. For example, the optical sheet 60′ in FIG. 4 can be formed by changing the shape of the stamping patterns on the roller 73 into semi-sphere troughs. In another example, by adjusting the valve 79 for increasing the outflow amount of the photo resin 20, i.e. the thickness of the photo resin 20 deposited on the transmission band 77 is increased; and by adding a plurality of light diffusion particles in the uncured photo resin 20, the optical sheet 60″ in FIG. 5 can then be formed.

While the preferred embodiment of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An optical sheet, placed in a backlight assembly, comprising pluralities of first microstructures on its surface, and being mainly made of cured photo resin.

2. The optical sheet recited in claim 1, wherein the photo resin is ultraviolet glue.

3. The optical sheet recited in claim 1, wherein the first microstructures are disposed on the emergence surface of the optical sheet, and the first microstructures are of prism shape.

4. The optical sheet recited in claim 1, wherein the first microstructures are disposed on the emergence surface of the optical sheet and of semi-sphere shape.

5. The optical sheet recited in claim 1, further comprising pluralities of light diffusion particles, wherein the light diffusion particles are distributed in the optical sheet.

6. The optical sheet recited in claim 1, wherein the thickness of the optical sheet is 50 μm.

7. A manufacturing method for an optical sheet, comprising:
providing a forming module, which has pluralities of second microstructures on its surface;
coating a layer of uncured photo resin over the second microstructures of the forming module;
covering a pressing plate, which is made of a transparent material that is not prone to crosslinking to the photo resin, on the uncured photo resin;
curing the photo resin to form an optical sheet; and
detaching the optical sheet from the forming module and the pressing plate.

8. The manufacturing method recited in claim 7, wherein the photo resin is ultraviolet glue.

9. The manufacturing method recited in claim 7, wherein the material of the pressing plate is oriented polypropylene.

10. The manufacturing method recited in claim 7, wherein the material of forming module is metal and the surface on which the second microstructures is disposed is coated with Teflon.

11. The manufacturing method recited in claim 7, wherein the viscosity of the uncured photo resin is above 50 cps.
